(19) United States
(12) Patent Application Publication
(10) Pub. No.: US 2005/0233040 A1
(43) Pub. Date: Oct. 20, 2005

(54) Method and device for homogenizing emulsions

(76) Inventors: Wolfgang Ehrfeld, MAINZ (DE); Andreas Fredenhagen, Coburg (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/513,845

(22) PCT Filed: Apr. 9, 2003
(86) PCT No.: PCT/EP03/03657

§ 371 Date: Jun. 20, 2005

(30) Foreign Application Priority Data
Apr. 17, 2002 (DE) 102 16 947.0

(51) Int. Cl. A23P 1/00

(52) U.S. Cl. 426/519

(57) ABSTRACT

Method and device for homogenizing emulsions, especially milk, wherein an emulsion is subjected to a high shearing force in a homoginizer equipped with microstructures.

The invention relates to a method for homogenizing emulsions, especially milk, which method uses a homogenizer equipped with special microstructures and makes it possible to reduce the size of the fat globules at a much lower operating pressure than has hitherto been possible.

Homogenization is an important process step in milk production. To obtain an emulsion which is stable for days or weeks, the fat globules contained in the milk must be small and uniformly dispersed. This fine dispersion also provides a more full-bodied taste. Homogenization of milk is presently carried out exclusively in high-pressure homogenizers. In these devices, in a method which has been used for over 100 years, the milk is conveyed at very high pressure through a narrow gap and, in this way, the globules of fat are reduced to sizes in the range of 0.3 to 0.4 μm.

The energy applied to reduce the size of the fat globules is three orders of magnitude higher than the energy application theoretically required to increase the surface area of the fat phase. If one assumes a uniform application of energy over volume, then the actual energy applied is still two orders of magnitude above the theoretical minimum. Despite constant refinement of the method, most of the energy introduced into the milk simply causes warming.

Thus, German patent application 197 00 810 describes a method for homogenizing milk, in which the milk is conveyed through a single-stage or multi-stage nozzle-type dispersal device. This method does not employ shearing forces produced by multiple deflections of flow within narrow microstructures or by holes with a diameter of under 1 μm. Instead, the homogenization there is effected, at nozzle diameters of over 100 μm, by the nozzle flow, and not by shearing of the droplets.

An improvement in efficacy would lead to a very significant technical advance. Besides decreasing the specific energy application, it would also be possible, in particular, to greatly simplify the technical design of the homogenizer apparatus, which would result in considerable savings in terms of production and maintenance costs.

Microtechnology has already been employed successfully in many areas of industry. The small structural dimensions involved permit high rates of thermal transfer, rapid mixing processes, and very precise flow control. In the food industry, scarcely any use has yet been made of the particular advantages of microtechnology in terms of process improvements, in particular improvement of fluid processes.

The object set was therefore to develop a method and a device for homogenizing emulsions, especially for homogenizing milk, by which the technical advantages of using microstructures can be exploited and the fat droplets in emulsions, especially in milk, can be uniformly reduced in size, this requiring a considerably lower operating pressure than hitherto, preferably an operating pressure of under 50 bar.

It has now been found that this object is achieved by a method for homogenizing emulsions in which the emulsion is subjected to high shearing forces in a flow field by means of a homogenizer equipped with microstructures, said shearing forces being generated by a multiplicity of mutually offset channel structures or flow obstacles placed in the stream of liquid.

The mutually offset flow obstacles designed as microstructures preferably have the shape of diamonds, triangles, crescents or other sharp-edged structures.

The materials used can be corrosion-resistant steels, for example, or ceramic substances. Production can be done using standard microtechnology production methods, for example the LIGA technique, deep-etch technique, spark erosion, laser ablation, or mechanical micromachining. The structures can be connected with a form fit, a materially integral fit or a force fit, for example by diffusion soldering, diffusion welding, electron beam welding, adhesive bonding, or pressing. Another method permitting inexpensive production of structures with fine flow obstacles is one in which thin metal wires are covered galvanically with a further layer of metal, for example a layer of silver, then pressed in parallel and fixed on a support plate, for example by welding. The outer layer of metal is then removed again by an etching solution, so that the desired structure is obtained.

Cleaning of the components is of great importance, particularly in food technology. Chemical cleaning agents can be used to do this in the homogenizer according to the invention. A further possibility is to use a design in which provision is made for mechanical cleaning. The microstructured plate is in this case inserted through a plate with openings in the shape of the flow obstacles into the flow space, so that cleaning can be effected by lowering of the microstructures.

FIG. 1 shows an arrangement of the diamond-shaped microstructures which are particularly preferred according to the invention and which are mutually offset in order to increase the shearing forces.

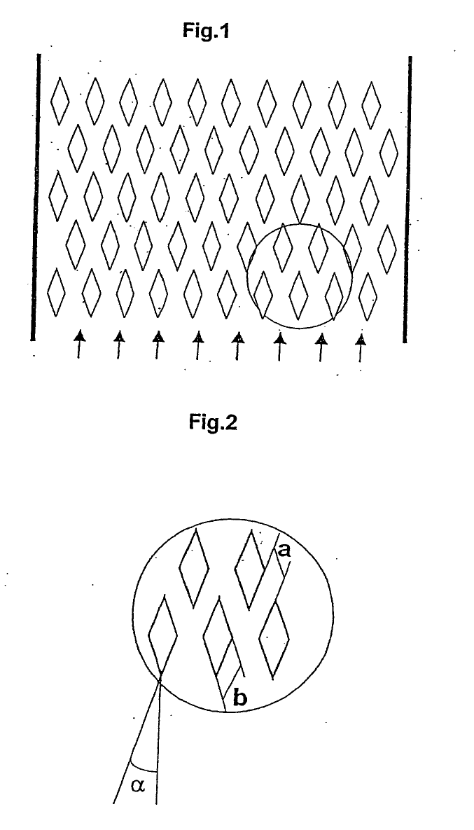

FIG. 2 shows the geometric dimensions (a), (b) and (α) which are important for generating optimal shearing forces and which can be varied depending on the properties of the emulsion to be homogenized and on the fat globule size to be achieved. Further variations are obtainable through the height of the microstructures and through the number of rows of microstructures arranged behind one another.

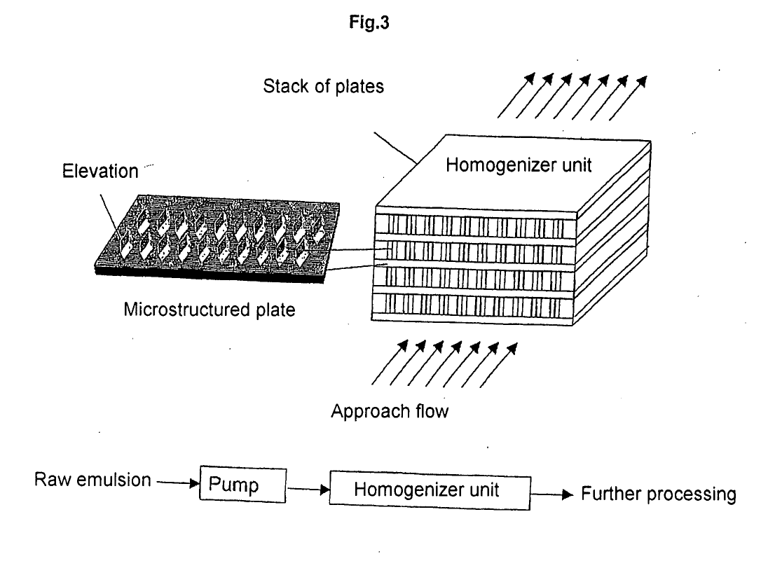

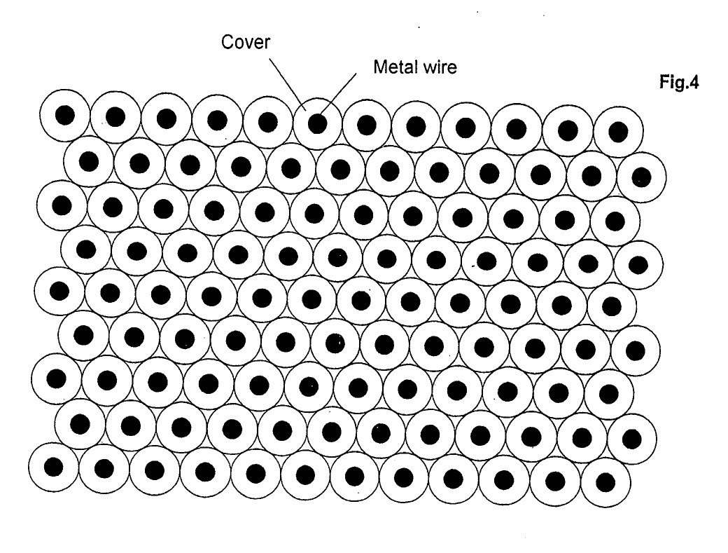

FIG. 3 shows the structure of a homogenizer containing microstructures according to the invention. One or more microstructured plates are stacked on top of one another in the homogenizer unit, in which plates the diamond-shaped cutouts have sharp-edged elevations at the margin which are responsible for creation of considerable shearing forces. The figure at the same time shows how the emulsion flows toward the stack of plates and how it leaves the latter again after homogenization. The raw emulsion, i.e. milk for example, is forced through the homogenizer unit by means of a pump and can then be further processed.

FIG. 4 shows a sharp-edged microstructure which has been produced from a layer of metal wires which are covered with a second metal and, after parallel pressing, are fixed on a support plate or between several support plates. The second metal is then dissolved out. For this method, metal wires with a diameter of less than 3 μm are advantageously used. It is particularly recommended to cover the metal wires with silver in the production method.

The shearing forces required to generate uniformly small globules of fat in an emulsion can also be generated by microstructures of different configuration. An apertured plate whose holes have a diameter of less than 1 μm has proven particularly suitable in this respect. This hole diameter is particularly suitable for homogenization of milk, where the fat globules, before emulsion, have a diameter of 3 to 25 μm and, after passage through the homogenizer, are intended to have a uniform globule size of less than 1 μm. A comparable effect is also obtained using micro channels whose narrowest cross section is smaller than 1 μm.

To produce the apertured plate that can be used according to the invention for homogenization of emulsions, the application of femtosecond lasers is of special interest since, when machining materials with a high thermal conductivity and a comparatively low melt temperature (for example metals), the melt adhesions which generally arise when using conventional laser beam sources, and which can considerably reduce the attainable precision, do not occur. Transparent materials, such as organic materials, can also be worked with minimal damage using these femtosecond lasers.

An apertured plate of this kind is preferably made from metal or glass.

In the method according to the invention, using an operating pressure of below 50 bar, i.e. much less than today's standard 200 bar, it is possible to produce a uniformly homogenized emulsion, in particular milk, with a globule size of below 1 μm and distinguished by a particularly long shelf life.

1. A method for homogenizing emulsions, wherein an emulsion is subjected to high shearing forces in a flow field in a homogenizer equipped with microstructures, said microstructures being a multiplicity of channel structures or flow obstacles placed in the flow field.

2. The method as claimed in claim 1, wherein said microstructures are mutually offset flow obstacles in the shape of diamonds, triangles, crescents or other sharp-edged structures.

3. The method as claimed in claim 1, wherein said microstructures are an apertured plate whose holes have a diameter of less than 1 μm.

4. The method as claimed in claim 3, wherein said holes in said apertured plate are generated by a femtosecond laser.

5. The method as claimed in the claim 1, wherein said emulsion comprises fat globules and said fat globules are reduced by said shearing forces to a size of under 1 μm.

6. The method as claimed in claim 1, wherein said homogenizer is operated at an operating pressure of under 50 bar.

7. The method as claimed in wherein said emulsion is milk.

8. A homogenizer having one or more microstructured, sharp-edged plates which are stacked on top of one another.

9. The device as claimed in claim 8, comprising an apertured plate with micro channels whose narrowest cross section is less than 1 μm.

10. A method for producing a the homogenizer of claim 8, wherein a layer of metal wires is covered with a second metal and, after parallel pressing, is fixed on a support plate or between several support plates, and the second metal is then dissolved out.

11. The method as claimed in claim 10, wherein said metal wires have a diameter of less than 3 μm.

12. The method as claimed in claim 10, wherein said second metal is silver.
